(19) United States
(12) Patent Application Publication
(10) Pub. No.: US 2025/0307750 A1
(43) Pub. Date: Oct. 2, 2025

(54) METHOD FOR RISK ANALYSIS AND CONTROL OF PRE-FLOOD ENERGY STORAGE IN A CASCADE HYDRO-WIND-SOLAR COMPLEMENTARY SYSTEM

(71) Applicant: DALIAN UNIVERSITY OF TECHNOLOGY, Dalian (CN)

(72) Inventors: Jianjian SHEN, Dalian (CN); Mengke LIN, Dalian (CN); Tingjie HAO, Dalian (CN); Xihai GUO, Dalian, Liaoning (CN); Linsong GE, Dalian (CN); Chuntian CHENG, Dalian (CN)

(21) Appl. No.: 19/234,960

(22) Filed: Jun. 11, 2025

Related U.S. Application Data
(63) Continuation of application No. PCT/CN2024/109110, filed on Aug. 1, 2024.

(51) Int. Cl. G06Q 10/0635; G06Q 50/06

(52) U.S. Cl. CPC G06Q 10/0635; G06Q 50/06

(57) ABSTRACT

This invention relates to the field of power system generation scheduling and discloses a method for risk analysis and control of pre-flood energy storage in cascade hydro-wind-solar complementary systems. Taking the pre-flood energy storage as a constraint, a dry-season drawdown model and a flood-season water storage operation rule are established to define simulation criteria. A comprehensive set of indicators, including dry-season power shortages, flood-season water spillage, inadequate year-end energy storage, and wind and solar power curtailment, is constructed to quantify multi-stage, multi-source operational risks. By coupling Monte Carlo simulation with fuzzy membership functions, the method characterizes multidimensional uncertainty scenarios and their probabilities, and analyzes the quantitative relationship between pre-flood energy storage and system benefits, risk probabilities as well as losses. Simulation results demonstrate that precise risk characterization coupled with proper storage control increases annual generation by 580 million kWh while reducing average risk-induced losses by 42%, demonstrating substantial practicality.

### TECHNICAL FIELD

The present invention relates to the field of power system dispatching, and particularly to a method for risk analysis and control of pre-flood energy storage in a cascade hydro-wind-solar complementary system.

### BACKGROUND TECHNOLOGY

To fully leverage China's vast hydropower resources with hundreds of gigawatts and develop hydro-wind-solar complementary systems has become a practical and reliable solution to alleviate wind and solar power flexibility constraints and promote its integration into the grid. However, the complementary operations should focus on the coordination of pre-flood energy storage for cascaded hydropower stations especially large-scale control-type stations. This significantly affect the role of hydropower in compensating wind and solar power generations. Traditional long-term scheduling methods for hydropower stations in hydro-wind-solar hybrid systems primarily are classified into three approaches. The first is optimizing long-term hydropower storage arrangements based on overall system benefits and long-term electricity fluctuations. The second is incorporating short-term wind and solar power demands and operational characteristics to enhance the reliability of long-term generation schedules. The third is introducing risk indicators as optimization criteria to reduce the risks associated with long-term scheduling.

Currently, most methods for long-term scheduling address only a single or a limited number of risk sources in their risk control frameworks (Wang Jin, Zhao Zhipeng, Cheng Chuntian, et al. Research on cascade hydro-wind-solar complementary operation rules coupling power damage depth and energy curtailment criterion [J]. Journal of Hydraulic Engineering, 2023, 54 (12): 1415-1429). However, in practice, hydro-wind-solar complementary systems face a wide range of complex, multi-source risks, including power shortages (Guo Y, Ming B, Huang Q, et al. Risk-averse day-ahead generation scheduling of hydro-wind-photovoltaic complementary systems considering the steady requirement of power delivery [J]. Applied Energy, 2022, 309:118467), wind and solar power curtailment (Ming Bo, Li Yan, Liu Pan, et al. Long-term optimal operation of hydro-solar hybrid energy systems nested with short-term energy curtailment risk [J]. Journal of Hydraulic Engineering, 2021, 52 (06): 712-722), water spillage at hydropower stations (Cao Rui, Cheng Chuntian, Shen Jianjian, et al. Long-term optimal operation of reservoir considering the water spillage risk during the impoundment period. Journal of Hydraulic Engineering, 2021. 52 (10): 1193-1203), and irrational control of cascade energy storage (Niu Wenjing, Wu Xinyu, Feng Zhongkai, et al. The Optimal Operation Method of Multi-reservoir System Under the Cascade Storage Energy Control. Proceedings of the CSEE, 2017. 37 (11): 3139-3147+3369), etc. Existing approaches rarely consider the need to balance and coordinate multiple operational risks in actual operations. Therefore, there is a pressing need to further quantify diverse risks in hydro-wind-solar complementary operations and to develop corresponding risk control strategies tailored to these risks.

Pre-flood energy storage control in cascade hydropower stations is a critical component of long-term scheduling. It directly affects water availability during the dry season and the water storage during the flood season. The annual time horizon can generally be divided into two main phases according to the pre-flood date, i.e., the drawdown phase (approximately January to June) and the storage adjustment phase (approximately July to December). Due to the seasonal variability in runoff and the intermittent nature of wind and solar energy, each phase imposes conflicting requirements on pre-flood energy storage control. Improper storage control can easily lead to major operational risks, including power shortages during the dry season, water spillage during the flood season, wind and solar power curtailment, and unreasonable year-end energy storage. Therefore, accurately identifying the relationship between pre-flood energy storage and various operational risks is essential for balancing these risks in a hydro-wind-solar complementary system.

To address the challenge, the present invention proposes a method for risk analysis and control of pre-flood energy storage in a cascade hydro-wind-solar complementary system, and validates its applicability using a real-world hydro-wind-solar complementary engineering on a large-scale river basin. Results demonstrate that the proposed method effectively quantifies the relationship between pre-flood energy storage and multiple risk factors, and significantly reduces system risks and operational losses in real-world applications of hydro-wind-solar complementary systems.

### Invention Content

The technical problem addressed by the present invention is to provide a method for analyzing and controlling the risk associated with pre-flood energy storage in a hydro-wind-solar complementary system. This method aims to characterize various types of risks and potential losses related to pre-flood energy storage, quantitatively assess multi-dimensional operational risks of the hydro-wind-solar complementary system, and enable the rational control of pre-flood energy storage in cascade hydropower stations.

### Technical Solution of the Present Invention:

A method for risk analysis and control of pre-flood energy storage in a cascade hydro-wind-solar complementary system, comprising the following steps:

(1) Constructing a dry-season drawdown optimization model based on the constraints of cascade pre-flood energy storage, monthly electricity generation control during the dry season, and conventional hydropower operation restrictions. The model is used to obtain the optimal dry-season drawdown plan. The objective function of the dry-season drawdown optimization model is as follows:

$$Max E = {\sum }_{j ∈ J} {\sum }_{n ∈ N} {\sum }_{t ∈ {T}_{1}} {P}_{j} ( \cdot {Ph}_{j , n , t} + {Pwp}_{j , t} ) Δ t \qquad ( 1 )$$

Where E is the expected generation for each scenario; J,T₁,N denote the runoff uncertainty scenarios, the number of dry-season scheduling periods and the set of hydropower stations, respectively, and j,t,n are corresponding set elements; Pⱼ is the probability of scenario j; Ph_{j,n,t} is the generation of hydropower station n of scenario j at time period t; Pwp_{j,t} is the wind and solar generation of scenario j at time period t; Δt is the duration(s) of each time period.

The pre-flood energy storage constraints and monthly electricity generation control constraints during the dry season are defined as follows:

### 1) Cascade Pre-Flood Energy Storage Constraint

$${\sum }_{n ∈ N} {E}_{n , {T}_{1}} = {E}_{tar} \qquad ( 2 )$$

$${E}_{n , {T}_{1}} = \frac{{V}_{n , {T}_{1}} + {\sum }_{nn ∈ {Ω}_{n}^{2}} {W}_{nn , {T}_{1}}}{{η}_{n}}$$

Where E_{n,T}¹ is the pre-flood storage capacity of hydropower station n; Eₜₐᵣ is the pre-flood energy storage target; V_{n,T}_{₁} refers to the storage volume of hydropower station n at the end of time horizon;

$${\sum }_{n n ∈ {Ω}_{n}^{2}} {W}_{nn , {T}_{1}}$$

refers to the sum of storage volume for upstream stations of hydropower station n, and Ωₙ², is the set of upstream stations of hydropower station n; ηₙ is the average water consumption rate of hydropower station n.

### 2) Monthly Electricity Generation Control Constraints During the Dry Season

$$\begin{matrix}\vert \frac{{\sum }_{n ∈ N} {Ph}_{j , n , t} + {Pwp}_{j , t}}{{\sum }_{t = 1}^{{T}_{1}} ( {\sum }_{n ∈ N} {Ph}_{j , n , t} + {Pwp}_{j , t} )} - {K}_{t} \vert \leq ξ & ∀ j , ∀ n , t ∈ {T}_{1}\end{matrix} \qquad ( 3 )$$

Where Kₜ is the control ratio of generation production at time period t to the total during the dry season (Historical statistics); ξ is the control error.

The Gurobi solver is used as the modeling and solution platform. Python programming, in combination with the Pyomo modeling language, is employed to linearize nonlinear constraints in the dry-season drawdown optimization model and convert the problem into a mixed-integer linear programming (MILP) formulation.

(2) Operation rules for water storage are constructed, including a five-stage hedging rule and an allocation method for cascade power generation. The cascade power generation allocation is determined using the K-value discrimination method.

(2.1) Develop hedging operation rules: A parametric linear optimization method is established using a Python-Pyomo modeling program to construct a five-stage hedging operation rule, which determines monthly power generations of the hydro-wind-solar complementary system. The operation principle is illustrated in FIG. 1. In the figure, OAGD represents a traditional three-stage operation rule for the hydro-wind-solar complementary system. Where OA denotes the generation range below the guaranteed level; AG represents the guaranteed generation segment, and GD denotes the increased generation segment. The hedging operation rule proposed in the present invention builds upon this three-stage framework by introducing two additional points, B and C, between the AG and GD segments. This forms a five-stage hedging rule, OABCD, which includes a hedging segment BC. In this rule, the horizontal coordinates of the intersection points between segment BC and segments AG and GD are defined as parameters a and b, respectively. These parameters are determined through optimization based on historical power generation records from hydropower, wind, and solar power sources. The specific expressions for calculating a and b are as follows:

$$Min D = {\sum }_{t}^{{T}_{2}} \vert {kE}_{t} + d - {P}_{t} \vert \qquad ( 4 )$$

Where k and d are the slope and intercept of the curve BC; Eₜ is the historical average available energy of the complementary system at time period t; T₂ is the number of periods during the storage adjustment period; Pₜ is the historical average generation at time period t; As BC intersects with sections AB and GD, a and b are calculated with the consideration of expressions for sections AB and GD, shown in the following equation:

$$a = \frac{{P}_{f} - d}{k} \qquad ( 5 )$$

$$b = \frac{[ ( d - 1 ) {P}_{f} Δ m + {dE}_{m}^{s} ] Δ m}{1 - k Δ m} \qquad ( 6 )$$

Where P_{M} is the maximum generation of the hydro-wind-solar complementary system; P_{f} is the guaranteed generation of the complementary system; Eₘ^{s} is the available energy storage of the full storage of cascade hydropower stations; Δm is the number of hours in a month.

(2.2) Cascade generation allocation: After obtaining monthly total generation of the hydro-wind-solar complementary system in step (2.1), the residual generation after deducting the wind and solar generations is allocated among cascade hydropower stations. The K-value discrimination method is applied to determine the sequence of water storage and release for the cascade system. Specifically, during the storage phase, stations with higher K-values are prioritized for water storage; during the supply phase, stations with lower K-values are prioritized for power generation. The discriminant value K for hydropower station n is calculated as follows:

$$Δ {E}_{x} = {W}_{n} / {φ}_{n}^{{V}_{n}} ( Δ {V}_{n} ) + {\sum }_{k ∈ {Ω}_{n}^{3}} Δ {V}_{n} / {η}_{k} \qquad ( 7 )$$

$$Δ {E}_{z} = {\sum }_{k ∈ {Ω}_{n}^{2}} ( {V}_{k} + {W}_{k} ) / {φ}_{n}^{{V}_{n}} ( Δ {V}_{n} ) \qquad ( 8 )$$

$${K}_{n} = \frac{Δ {E}_{z}}{Δ {E}_{x}} = \frac{{\sum }_{k ∈ {Ω}_{n}^{2}} ( {V}_{k} + {W}_{k} )}{{W}_{n} + {φ}_{n}^{{V}_{n}} ( Δ {V}_{n} ) \times {\sum }_{k ∈ {Ω}_{n}^{3}} Δ {V}_{n} / {η}_{k}} \qquad ( 9 )$$

Where ΔEₓ denotes the energy added to hydropower station n and downstream stations due to the storage of water ΔVₛ in station n; Wₙ/φₙ^{V}^{ₙ} (ΔVₙ) is the incremental energy in the hydropower station n due to the increase in water head, Wₙ is the current storage volume of hydropower station n;

$${\sum }_{k ∈ {Ω}_{n}^{3}} Δ {V}_{n} / {η}_{k}$$

is the energy added to downstream hydropower stations due to the storage of water ΔVₙ in hydropower station n, and Ωₙ³ denotes the set of downstream hydropower stations of power station n; ΔVₙ is the unit storage volume in hydropower station n; ηₖ is the average water consumption rate in hydropower station n from the initial water level to the stored water level; ΔE_{z} denotes the energy added to the upstream hydropower plant due to water storage ΔVₙ at hydropower station n; Ωₙ² denotes the set of upstream stations of hydropower station n; Vₖ denotes the amount of water stored above the dead storage volume of upstream hydropower station n, and Wₖ is the amount of interval inflow of hydropower station k; φₙ^{V}^{ₙ}(⋅) is a relationship function between changes in the unit storage volume and changes in the water consumption rate when the storage volume of hydropower station n is Vₙ.

(3) Using fuzzy theory to characterize high-dimensional, multiple uncertainty probabilities of runoff, wind power and solar power.

(3.1) Assuming that the forecast errors of runoff and wind/solar power generation are fuzzy variables, and that the distribution of these forecast errors follows a Cauchy distribution, the membership function representing the prediction error ε of runoff or wind and solar power generation is expressed as follows:

$$μ ( ε ) = \{ \begin{matrix}\frac{1}{1 + {σ ( ε / EP )}^{2}} & ε > 0 \\ \frac{1}{1 + {σ ( ε / EN )}^{2}} & ε \leq 0\end{matrix} \qquad ( 10 )$$

Where EP and EN are statistical means of the positive and negative errors in the uncertainty sets for runoff or wind and solar power generation, and σ is a weight.

(3.2) The Python programming language is used to import long-sequence predicted and historical records of runoff and wind/solar power generation data from Excel files. The cauchy.fit function included in the SciPy library is then employed to fit the Cauchy distribution parameters to the calculated prediction error data.

(3.3) To represent the comprehensive membership degree between runoff and wind/solar power generation at each power station within the same time period, as well as across different time periods, the following two types of fuzzy relationships are defined:

The fuzzy relationship between the runoff and wind/solar power generation during the same time period is defined as follows:

$${h}_{1} ( Q {1}_{t} , Q {2}_{t} , … , {Qn}_{t} , {Pwp}_{t} ) = min \{ f ( Q {1}_{t} ) , f ( Q {2}_{t} ) , … , f ( {Qn}_{t} ) , f ( {Pwp}_{t} ) \} \qquad ( 11 )$$

Where Q1ₜ, Q2ₜ, . . . , Qnₜ are the inflow or interval flow of hydropower stations 1, 2, . . . , n at time period t, respectively; Pwpₜ is the wind and solar power generation at time period t; f(⋅) is the corresponding membership degree function.

The fuzzy relationship between the runoff and wind/solar power generation at different time periods is expressed as follows:

$${h}_{2} ( {Q}_{1}^{n} , {Q}_{2}^{n} , … , {Q}_{T}^{n} ) = min \{ f ( {Q}_{1}^{n} ) , f ( {Q}_{2}^{n} ) , … , f ( {Q}_{T}^{n} ) \} \qquad ( 12 )$$

$${h}_{3} ( {Pwp}_{1} , {Pwp}_{2} , … , {Pwp}_{T} ) = min \{ f ( {Pwp}_{1} ) , f ( {Pwp}_{2} ) , … , f ( {Pwp}_{T} ) \} \qquad ( 13 )$$

Where h₂(⋅) and h₃(⋅) are the fuzzy relationship between the runoff at different time periods and between the wind and solar power generation at different time periods, denoting the comprehensive membership degree; Q₁ⁿ, Q₂ⁿ, . . . , Q_{T}ⁿ are the runoff of the power station n at time periods 1, 2, . . . , T; Pwp₁, Pwp₂, . . . . Pwp_{T} are the wind and solar power generations at time periods 1, 2, . . . , T.

(4) Key risk indicators for both flood and dry season are selected to establish a comprehensive set of critical risk indexes for the hydro-wind-solar complementary system, shown as follows:

(4.1) The risk of power shortage in the dry season, denoted as R_{w}, is defined as follows:

$${R}_{s} = \frac{sum \{ {P}_{i}^{shortage} \}}{I} i ∈ I \qquad ( 14 )$$

$${P}_{i}^{shortage} = \{ \begin{matrix}1 & ∃ {P}_{i , t} < {P}_{f} & t ∈ {T}_{1} \\ 0 & ∀ {P}_{i , t} \geq {P}_{f} & t ∈ {T}_{1}\end{matrix} \qquad ( 15 )$$

Where Pᵢ^{shortage} is the risk value of generation deficit under scenario i, Pᵢ^{shortage} is set to 1 if risk exists otherwise 0; P_{i,t} is the system generation value at time period t of scenario i; I is the total number of simulated scenarios; T₁ is the total number of time periods during the dry season; P_{f} is the guaranteed generation for the hydro-wind-solar complementary system.

(4.2) The water spillage risk in the flood season, denoted as R_{w}, is defined as follows:

$${R}_{w} = \frac{num \{ {S}_{i} > Sd \}}{I} i ∈ I \qquad ( 16 )$$

$${S}_{i} = {\sum }_{t = 1}^{{T}_{2}} {spill}_{i , t} t ∈ {T}_{2} \qquad ( 17 )$$

Where Sᵢ represents the spilled water in scenario i; Sd is the spillage control threshold; spill_{i,t} represents the spilled water in scenario i at time period t.

(4.3) The risk of insufficient year-end energy storage, denoted as Rₑ, is defined as follows:

$${R}_{e} = \frac{num \{ {Eend}_{i} < {E}_{min} \}}{I} i ∈ I \qquad ( 18 )$$

Where Eendᵢ is the energy storage at the end of a year in scenario i; Eₘᵢₙ is the minimum requirement for energy storage of the system at the end of a year, below which the energy storage is deemed inadequate.

(4.4) The risk of wind and solar power curtailment, denoted as R_{c}, is defined as follows:

$${R}_{c} = \frac{num \{ {C}_{i} > Cd \}}{I} i ∈ I \qquad ( 19 )$$

$${C}_{i} = {\sum }_{t = 1}^{T} {curtail}_{i , t} t ∈ T \qquad ( 20 )$$

$${curtail}_{i , t} = f ( {Ph}_{i , t} ) t ∈ T \qquad ( 21 )$$

Where Cᵢ is the wind and solar power curtailment of scenario i; Cd is the threshold of wind and solar power curtailment; curtail_{i,t} is the wind and solar power curtailment of scenario i at time period t; f(⋅) is the power curtailment function of the hydro-wind-solar complementary system; Ph_{i,t} is the hydropower generation of scenario i at time period t; T is the number of time periods in a year.

The risks of power shortage during the dry season, water spillage during the flood season, insufficient energy storage at the end of a year, and wind and solar power curtailment for each scenario are respectively calculated as follows:

$${L}_{i}^{s} = {\sum }_{t = 1}^{{T}_{1}} {μ}_{i , t} \times max \{ {P}_{f} - {P}_{i , t} , 0 \} \qquad ( 22 )$$

$${L}_{i}^{w} = {μ}_{i} \times {S}_{i} \qquad ( 23 )$$

$${L}_{i}^{e} = {μ}_{i} \times max \{ {E}_{min} - {Eend}_{i} , 0 \} \qquad ( 24 )$$

$${L}_{i}^{c} = {μ}_{i} \times {C}_{i} \qquad ( 25 )$$

Where Lᵢ^{s}, Lᵢ^{w}, Lᵢ^{e}, Lᵢ^{c} are index loss values of Rₛ, R_{w}, Rₑ and R_{c}, respectively; μ_{i,t} is the fuzzy membership degree of scenario i at time period t; u; is the comprehensive fuzzy membership degree of scenario i.

(5) Quantification of risks for dry-season power shortages, flood-season water spillage, wind and solar power curtailment, and insufficient energy storage at the end of a year.

The prediction errors of runoff, wind, and solar power generation are represented as fuzzy variables. Wind and solar power generation are collectively referred to as new energy sources, without the consideration of their differences. The steps for quantifying risks are as follows:

(5.1) Based on historical records of the runoff and prediction and historical data of wind/solar power generation, the cauchy.fit function from the Python-Scipy library is utilized to calculate the parameters of membership functions of runoff and wind/solar power generation. Thus, the fuzzy membership degree functions f^{z}(ξₘ³) of the runoff prediction error and new energy generation prediction error can be determined, respectively, (1≤m≤12, 1≤z≤Z). Here, z denotes the uncertainty variable of the runoff or wind/solar power generation; m denotes the month index.

(5.2) Based on the error membership degree functions of the runoff and the wind/solar power generation, a series of real numbers ε_{m,k}^{z} and the corresponding membership degree μ(ε_{m,k}^{z}) (k=1, 2, . . . , N) are randomly generated using the Monte Carlo simulation method in the Python-random program package. N is the number of random numbers.

(5.3) Simulation operations are performed. During the dry season, monthly simulations are conducted from starting from the beginning of a year, using a fixed water level calculation based on the dry-season drawdown plan. For any a month, a series of ε_{m,k}^{z} based on the initial and ending water levels in the plan are generated. Thus, a series of total generation of the complementary system Ps_{m,k} and dry-season wind and solar power curtailment Cₖ¹ are obtained, and the membership degree h({ε_{m,k}^{z})}) can be determined. When the ending water level in the plan is infeasible, the simulated value replaces it in further calculations. During the flood season, the five stage operation rule is used for monthly simulations; Starting from the beginning of the flood season, a series of εₖ^{z} are generated. Here is εₖ^{z}={ε_{ml,k}^{z}, ε_{ml+1,k}^{z}, ε_{ml+2,k}^{z}, . . . , ε_{12,k}^{z}} for any scenario εₖ^{z}. Thus, the year-end energy storage Eendₖ, flood-season wind and solar power curtailment Cₖ², flood-season water spillage Sₖ, and their corresponding membership degrees h are obtained, respectively, f(εₖ^{z})=h(ε_{ml,k}^{z}, ε_{ml+1,k}^{z}, . . . , ε_{12,k}^{z}). ml represents the starting month of the flood season. The sum of Cₖ¹ and Cₖ² is the annual wind and solar power curtailment in the scenario k.

(5.4) The indicators Rₛ, R_{w}, Rₑ, R_{c}, and Lᵢ^{s}, Lᵢ^{w}, Lᵢ^{e}, Lᵢ^{c} for dry-season power shortages, flood-season water spillage, inadequate year-end energy storage, and wind and solar power curtailment are calculated according to step (3).

(5.5) For other hydropower plants in the cascade, the steps (5.2) to (5.6) are repeated to pre-calculate flood energy storage values. Finally, detailed relationships between cascade energy storage and dry-season power shortage, flood-season water spillage, inadequate year-end energy storage, and wind and solar power curtailment are obtained.

Compared with existing methods, the present invention offers an advantage of deriving a refined relationship between pre-flood energy storage and multi-dimensional operational risks as well as system benefits of hydro-wind-solar systems. This enables dispatchers to accurately assess potential risks and maximum losses associated with pre-flood energy storage decisions under multiple uncertainties, thereby facilitating multi-dimensional risk control and achieving a risk-balanced, cost-effective pre-flood energy storage control strategy.

### ATTACHED IMAGE DESCRIPTION

FIG. 1 is a schematic diagram of five stage scheduling rules for a hydro-wind-solar complementary system;

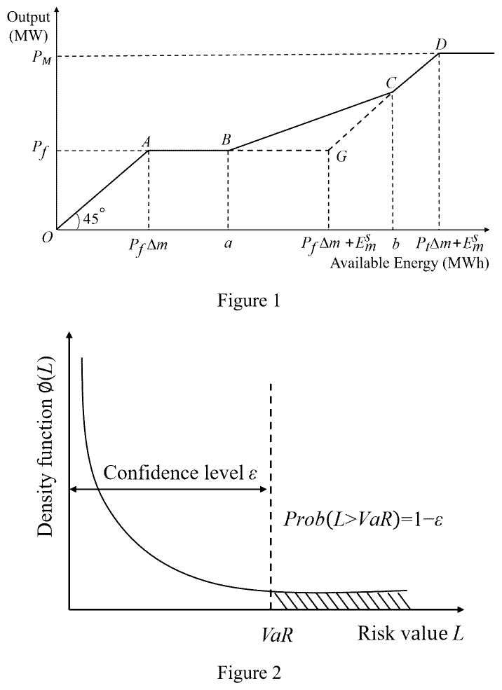

FIG. 2 is a schematic diagram of the risk loss distribution VaR;

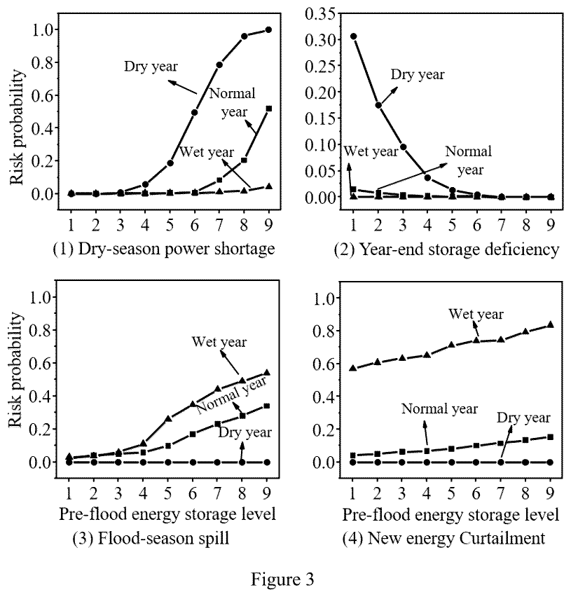

FIG. 3 illustrates the relationship between pre-flood energy storage and various risk probabilities. Specifically: (1) represents the risk of power shortages during the dry season; (2) indicates the risk of insufficient energy storage at the end of the year; (3) reflects the risk of water spillage during the flood season; and (4) denotes the risk of wind and solar power curtailment.

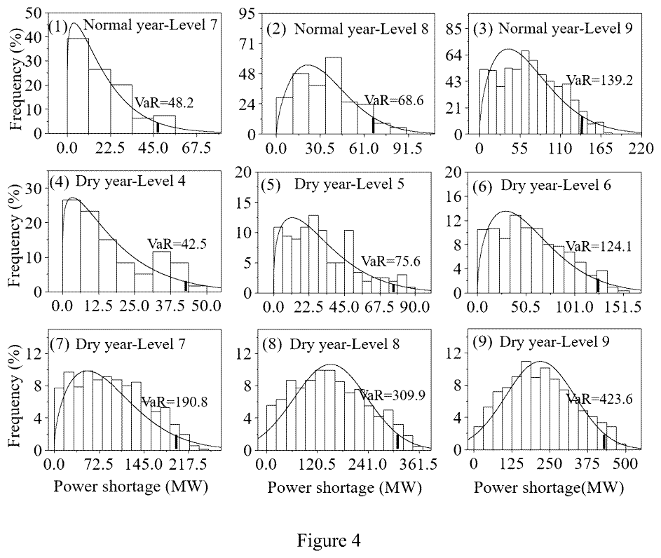

FIG. 4 shows the distribution of power shortage losses and corresponding risk values during the dry season. Specifically: (1) Normal year-Pre-flood energy storage level 7; (2) Normal year-Pre-flood energy storage level 8; (3) Dry year-Pre-flood energy storage level 9; (4) Dry year-Pre-flood energy storage level 4; (5) Dry year-Pre-flood energy storage level 5; (6) Dry year-Pre-flood energy storage level 6; (7) Dry year-Pre-flood energy storage level 7; (8) Dry year-Pre-flood energy storage level 8; (9) Dry year-Pre-flood energy storage level 9.

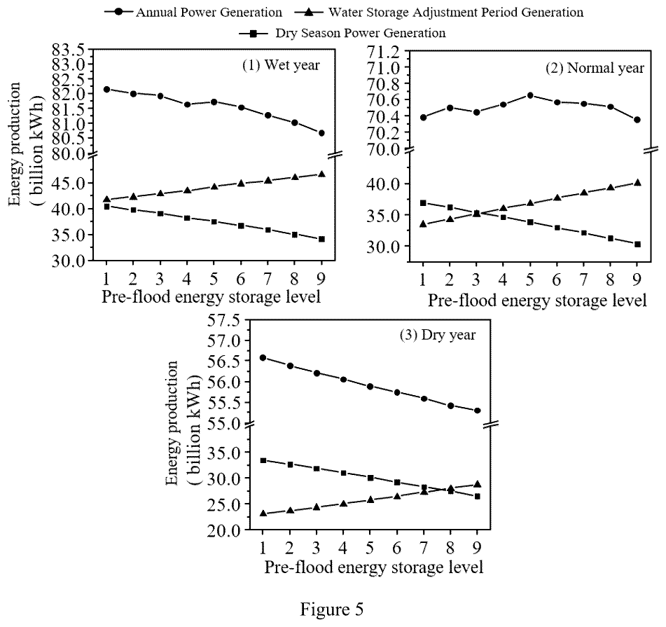

FIG. 5 shows the system power generation under different pre-flood energy storage levels. Specifically: (1) Wet year; (2) Normal year; (3) Dry year.

### Specific Implementation

The following provides a detailed description of the specific implementation of the present invention, with the accompanying drawings and technical solutions.

A method for risk analysis and control of pre-flood energy storage in a cascaded hydro-wind-solar complementary system, comprising the following steps:

(1) Constructing a dry-season drawdown optimization model based on the constraints of cascade pre-flood energy storage, monthly electricity generation control during the dry season, and conventional hydropower operation restrictions. The model is used to obtain the optimal dry-season drawdown plan. The objective function of the dry-season drawdown optimization model is as follows:

$$Max E = {\sum }_{j ∈ J} {\sum }_{n ∈ N} {\sum }_{t ∈ {T}_{1}} {P}_{j} ( \cdot {Ph}_{j , n , t} + {Pwp}_{j , t} ) Δ t \qquad ( 1 )$$

Where E is the expected generation for each scenario; J,T₁,N denote the runoff uncertainty scenarios, the number of dry-season scheduling periods and the set of hydropower stations, respectively, and j,t,n are corresponding set elements; P is the probability of scenario j; Ph_{j,n,t} is the generation of hydropower station n of scenario j at time period t; Pwp_{j,t} is the wind and solar generation of scenario j at time period t; Δt is the duration(s) of each time period.

The pre-flood energy storage constraints and monthly electricity generation control constraints during the dry season are defined as follows:

### 1) Cascade Pre-Flood Energy Storage Constraint

$${\sum }_{n ∈ N} {E}_{n , {T}_{1}} = {E}_{tar} \qquad ( 2 )$$

$${E}_{n , {T}_{1}} = \frac{{V}_{n , {T}_{1}} + {\sum }_{nn ∈ {Ω}_{n}^{2}} {W}_{nn , {T}_{1}}}{{η}_{n}}$$

Where E_{n,T}_{₁} is the pre-flood storage capacity of hydropower station n: Eₜₐᵣ is the pre-flood energy storage target: V_{n,T}_{₁} refers to the storage volume of hydropower station n at the end of time horizon;

$${\sum }_{nn ∈ {Ω}_{n}^{2}} {W}_{nn , {T}_{1}}$$

refers to the sum of storage volume for upstream stations of hydropower station n, and Ωₙ² is the set of upstream stations of hydropower station n: n, is the average water consumption rate of hydropower station n.

### 2) Monthly Electricity Generation Control Constraints During the Dry Season

$$\vert \frac{{\sum }_{n ∈ N} {Ph}_{j , n , t} + {Pwp}_{j , t}}{{\sum }_{t = 1}^{{T}_{1}} ( {\sum }_{n ∈ N} {Ph}_{j , n , t} + {Pwp}_{j , t} )} - {K}_{t} \vert \leq ξ ∀ j , ∀ n , t ∈ {T}_{1} \qquad ( 3 )$$

Where Kₜ is the control ratio of generation production at time period t to the total during the dry season; ξ is the control error.

The Gurobi solver is used as the modeling and solution platform. Python programming, in combination with the Pyomo modeling language, is employed to linearize nonlinear constraints in the dry-season drawdown optimization model and convert the problem into a mixed-integer linear programming (MILP) formulation.

(2) Operation rules for water storage are constructed, including a five-stage hedging rule and an allocation method for cascade power generation. The cascade power generation allocation is determined using the K-value discrimination method.

(2.1) Develop hedging operation rules: A parametric linear optimization method is established using a Python-Pyomo modeling program to construct a five-stage hedging operation rule, which determines monthly power generations of the hydro-wind-solar complementary system. The operation principle is illustrated in FIG. 1. In the figure, OAGD represents a traditional three-stage operation rule for the hydro-wind-solar complementary system. Where OA denotes the generation range below the guaranteed level; AG represents the guaranteed generation segment, and GD denotes the increased generation segment. The hedging operation rule proposed in the present invention builds upon this three-stage framework by introducing two additional points, B and C, between the AG and GD segments. This forms a five-stage hedging rule, OABCD, which includes a hedging segment BC. In this rule, the horizontal coordinates of the intersection points between segment BC and segments AG and GD are defined as parameters a and b, respectively. These parameters are determined through optimization based on historical power generation records from hydropower, wind, and solar power sources. The specific expressions for calculating a and b are as follows:

$$Min D = {\sum }_{t}^{{T}_{2}} \vert {kE}_{t} + d - {P}_{t} \vert \qquad ( 4 )$$

Where k and d are the slope and intercept of the curve BC; Eₜ is the historical average available energy of the complementary system at time period t; T₂ is the number of periods during the storage adjustment period; Pₜ is the historical average generation at time period t; As BC intersects with sections AB and GD, a and b are calculated with the consideration of expressions for sections AB and GD, shown in the following equation:

$$a = \frac{{P}_{f} - d}{k} \qquad ( 5 )$$

$$b = \frac{[ ( d - 1 ) {P}_{f} Δ m + {dE}_{m}^{s} ] Δ m}{1 - k Δ m} \qquad ( 6 )$$

Where P_{M} is the maximum generation of the hydro-wind-solar complementary system; P_{f} is the guaranteed generation of the complementary system; Eₘ^{s} is the available energy storage of the full storage of cascade hydropower stations; Δm is the number of hours in a month.

(2.2) Cascade generation allocation: After obtaining monthly total generation of the hydro-wind-solar complementary system in step (2.1), the residual generation after deducting the wind and solar generations is allocated among cascade hydropower stations. The K-value discrimination method is applied to determine the sequence of water storage and release for the cascade system. Specifically, during the storage phase, stations with higher K-values are prioritized for water storage; during the supply phase, stations with lower K-values are prioritized for power generation. The discriminant value K for hydropower station n is calculated as follows:

$$Δ {E}_{x} = {W}_{n} / {φ}_{n}^{{V}_{n}} ( Δ {V}_{n} ) + {\sum }_{k ∈ {Ω}_{n}^{3}} Δ {V}_{n} / {η}_{k} \qquad ( 7 )$$

$$Δ {E}_{z} = {\sum }_{k ∈ {Ω}_{n}^{2}} ( {V}_{k} + {W}_{k} ) / {φ}_{n}^{{V}_{n}} ( Δ {V}_{n} ) \qquad ( 8 )$$

$${K}_{n} = \frac{Δ {E}_{z}}{Δ {E}_{x}} = \frac{{\sum }_{k ∈ {Ω}_{n}^{2}} ( {V}_{k} + {W}_{k} )}{{W}_{n} + {φ}_{n}^{{V}_{n}} ( Δ {V}_{n} ) \times {\sum }_{k ∈ {Ω}_{n}^{3}} Δ {V}_{n} / {η}_{k}} \qquad ( 9 )$$

Where ΔEₓ denotes the energy added to hydropower station n and downstream stations due to the storage of water ΔVₙ in station n; Wₙ/φₙ^{V}^{ₙ} (ΔVₙ) is the incremental energy in the hydropower station n due to the increase in water head, Wₙ is the current storage volume of hydropower station n;

$${\sum }_{k ∈ {Ω}_{n}^{3}} Δ {V}_{n} / {η}_{k}$$

is the energy added to downstream hydropower stations due to the storage of water ΔVₙ in hydropower station n, and Ωₙ³ denotes the set of downstream hydropower stations of power station n; ΔVₙ is the unit storage volume in hydropower station n; ηₖ is the average water consumption rate in hydropower station n from the initial water level to the stored water level; ΔE_{z} denotes the energy added to the upstream hydropower plant due to water storage ΔVₙ at hydropower station n; Ωₙ² denotes the set of upstream stations of hydropower station n; Vₖ denotes the amount of water stored above the dead storage volume of upstream hydropower station n, and Wₖ is the amount of interval inflow of hydropower station k; φₙ^{V}^{ₙ} (⋅) is a relationship function between changes in the unit storage volume and changes in the water consumption rate when the storage volume of hydropower station n is Vₙ.

(3) Using fuzzy theory to characterize high-dimensional, multiple uncertainty probabilities of runoff, wind power and solar power.

(3.1) Assuming that the forecast errors of runoff and wind/solar power generation are fuzzy variables, and that the distribution of these forecast errors follows a Cauchy distribution, the membership function representing the prediction error ε of runoff or wind and solar power generation is expressed as follows:

$$μ ( ε ) = \{ \begin{matrix}\frac{1}{1 + {σ ( ε / EP )}^{2}} & ε > 0 \\ \frac{1}{1 + {σ ( ε / EN )}^{2}} & ε \leq 0\end{matrix} \qquad ( 10 )$$

Where EP and EN are statistical means of the positive and negative errors in the uncertainty sets for runoff or wind and solar power generation, and σ is a weight.

(3.2) The Python programming language is used to import long-sequence predicted and historical records of runoff and wind/solar power generation data from Excel files. The cauchy.fit function included in the SciPy library is then employed to fit the Cauchy distribution parameters to the calculated prediction error data.

(3.3) To represent the comprehensive membership degree between runoff and wind/solar power generation at each power station within the same time period, as well as across different time periods, the following two types of fuzzy relationships are defined:

The fuzzy relationship between the runoff and wind/solar power generation during the same time period is defined as follows:

$${h}_{1} ( Q {1}_{t} , Q {2}_{t} , … , {Qn}_{t} , {Pwp}_{t} ) = min \{ f ( Q {1}_{t} ) , f ( Q {2}_{t} ) , … , f ( {Qn}_{t} ) , f ( {Pwp}_{t} ) \} \qquad ( 11 )$$

Where Q1ₜ, Q2ₜ, . . . , Qnₜ are the inflow or interval flow of hydropower stations 1, 2, . . . , n at time period t, respectively; Pwpₜ is the wind and solar power generation at time period t; f(⋅) is the corresponding membership degree function.

The fuzzy relationship between the runoff and wind/solar power generation at different time periods is expressed as follows:

$${h}_{2} ( {Q}_{1}^{n} , {Q}_{2}^{n} , … , {Q}_{T}^{n} ) = min \{ f ( {Q}_{1}^{n} ) , f ( {Q}_{2}^{n} ) , … , f ( {Q}_{T}^{n} ) \} \qquad ( 12 )$$

$${h}_{3} ( {Pwp}_{1} , {Pwp}_{2} , … , {Pwp}_{T} ) = min \{ f ( {Pwp}_{1} ) , f ( {Pwp}_{2} ) , … , f ( {Pwp}_{T} ) \} \qquad ( 13 )$$

Where h₂(⋅) and h₃(⋅) are the fuzzy relationship between the runoff at different time periods and between the wind and solar power generation at different time periods, denoting the comprehensive membership degree; Q₁ⁿ, Q₂ⁿ, . . . , Q_{T}ⁿ are the runoff of the power station n at time periods 1, 2, . . . , T; Pwp₁, Pwp₂, . . . , Pwp_{T} are the wind and solar power generations at time periods 1, 2, . . . , T.

(4) Key risk indicators for both flood and dry season are selected to establish a comprehensive set of critical risk indexes for the hydro-wind-solar complementary system, shown as follows:

(4.1) The risk of power shortage in the dry season, denoted as Rₛ, is defined as follows:

$${R}_{s} = \frac{sum \{ {P}_{i}^{shortage} \}}{I} i ∈ I \qquad ( 14 )$$

$${P}_{i}^{shortage} = \{ \begin{matrix}1 & ∃ {P}_{i , t} < {P}_{f} & t ∈ {T}_{1} \\ 0 & ∀ {P}_{i , t} \geq {P}_{f} & t ∈ {T}_{1}\end{matrix} \qquad ( 15 )$$

Where Pᵢ^{shortage} is the risk value of generation deficit under scenario i, Pᵢ^{shortage} is set to 1 if risk exists otherwise 0; P_{i,t} is the system generation value at time period t of scenario i; I is the total number of simulated scenarios; T₁ is the total number of time periods during the dry season; P_{f} is the guaranteed generation for the hydro-wind-solar complementary system.

(4.2) The water spillage risk in the flood season, denoted as R_{w}, is defined as follows:

$${R}_{w} = \frac{num \{ {S}_{i} > Sd \}}{I} i ∈ I \qquad ( 16 )$$

$${S}_{i} = {\sum }_{t = 1}^{{T}_{2}} {spill}_{i , t} t ∈ {T}_{2} \qquad ( 17 )$$

Where Sᵢ represents the spilled water in scenario i; Sd is the spillage control threshold; spill_{i,j} represents the spilled water in scenario i at time period t.

(4.3) The risk of insufficient year-end energy storage, denoted as Rₑ, is defined as follows:

$${R}_{e} = \frac{num \{ {Eend}_{i} < {E}_{min} \}}{I} i ∈ I \qquad ( 18 )$$

Where Eendᵢ is the energy storage at the end of a year in scenario i; Eₘᵢₙ is the minimum requirement for energy storage of the system at the end of a year, below which the energy storage is deemed inadequate.

(4.4) The risk of wind and solar power curtailment, denoted as R_{c}, is defined as follows:

$${R}_{c} = \frac{num \{ {C}_{i} > Cd \}}{I} i ∈ I \qquad ( 19 )$$

$${C}_{i} = {\sum }_{t = 1}^{T} {curtail}_{i , t} t ∈ T \qquad ( 20 )$$

$${curtail}_{i , t} = f ( {Ph}_{i , t} ) t ∈ T \qquad ( 21 )$$

Where Cᵢ is the wind and solar power curtailment of scenario i; Cd is the threshold of wind and solar power curtailment; curtail_{i,t} is the wind and solar power curtailment of scenario i at time period t; f(⋅) is the power curtailment function of the hydro-wind-solar complementary system; Ph_{i,t} is the hydropower generation of scenario i at time period t; T is the number of time periods in a year.

The risks of power shortage during the dry season, water spillage during the flood season, insufficient energy storage at the end of a year, and wind and solar power curtailment for each scenario are respectively calculated as follows:

$${L}_{i}^{s} = {\sum }_{t = 1}^{{T}_{1}} {μ}_{i , t} \times max \{ {P}_{f} - {P}_{i , t} , 0 \} \qquad ( 22 )$$

$${L}_{i}^{w} = {μ}_{i} \times {S}_{i} \qquad ( 23 )$$

$${L}_{i}^{e} = {μ}_{i} \times max \{ {E}_{min} - {Eend}_{i} , 0 \} \qquad ( 24 )$$

$${L}_{i}^{c} = {μ}_{i} \times {C}_{i} \qquad ( 25 )$$

Where Lᵢ^{s}, Lᵢ^{w}, Lᵢ^{e}, Lᵢ^{c} are index loss values of Rₛ, R_{w}, Rₑ and R_{c}, respectively; μ_{i,t} is the fuzzy membership degree of scenario i at time period t; u; is the comprehensive fuzzy membership degree of scenario i.

(5) Quantification of risks for dry-season power shortages, flood-season water spillage, wind and solar power curtailment, and insufficient energy storage at the end of a year.

The prediction errors of runoff, wind, and solar power generation are represented as fuzzy variables. Wind and solar power generation are collectively referred to as new energy sources, without the consideration of their differences. The steps for quantifying risks are as follows:

(5.1) Based on historical records of the runoff and prediction and historical data of wind/solar power generation, the cauchy.fit function from the Python-Scipy library is utilized to calculate the parameters of membership functions of runoff and wind/solar power generation. Thus, the fuzzy membership degree functions f^{z}(ξₘ³) of the runoff prediction error and new energy generation prediction error can be determined, respectively, (1≤m≤12, 1≤z≤Z). Here, z denotes the uncertainty variable of the runoff or wind/solar power generation; m denotes the month index.

(5.2) Based on the error membership degree functions of the runoff and the wind/solar power generation, a series of real numbers ε_{m,k}^{z} and the corresponding membership degree μ(ε_{m,k}^{z}) (k=1, 2, . . . , N) are randomly generated using the Monte Carlo simulation method in the Python-random program package. N is the number of random numbers.

(5.3) Simulation operations are performed. During the dry season, monthly simulations are conducted from starting from the beginning of a year, using a fixed water level calculation based on the dry-season drawdown plan. For any a month, a series of ε_{m,k}^{z} based on the initial and ending water levels in the plan are generated. Thus, a series of total generation of the complementary system Ps_{m,k} and dry-season wind and solar power curtailment Cₖ¹ are obtained, and the membership degree h({ε_{m,k}^{z}}) can be determined. When the ending water level in the plan is infeasible, the simulated value replaces it in further calculations. During the flood season, the five stage operation rule is used for monthly simulations; Starting from the beginning of the flood season, a series of εₖ^{z} are generated. Here is εₖ^{z}={ε_{ml,k}^{z}, ε_{ml+1,k}^{z}, ε_{ml+2,k}^{z}, . . . , ε_{12,k}^{z}} for any scenario Thus, the year-end energy storage Eendₖ, flood-season wind and solar power curtailment Cₖ², flood-season water spillage Sₖ, and their corresponding membership degrees h are obtained, respectively, f(εₖ^{z})=h(ε_{ml,k}^{z}, ε_{ml+1,k}^{z}, . . . , ε_{12,k}^{z}). ml represents the starting month of the flood season. The sum of Cₖ¹ and Cₖ² is the annual wind and solar power curtailment in the scenario k.

(5.4) The indicators Rₛ, R_{w}, Rₑ, R_{c} and Lᵢ^{s}, Lᵢ^{w}, Lᵢ^{e}, Lᵢ^{c} for dry-season power shortages, flood-season water spillage, inadequate year-end energy storage, and wind and solar power curtailment are calculated according to step (3).

(5.5) For other hydropower plants in the cascade, the steps (5.2) to (5.6) are repeated to pre-calculate flood energy storage values. Finally, detailed relationships between cascade energy storage and dry-season power shortage, flood-season water spillage, inadequate year-end energy storage, and wind and solar power curtailment are obtained.

The present invention is validated using a large hydro-wind-solar complementary base located downstream of a major basin. The cascade hydropower stations selected are four reservoirs, including XW, MW, NZD, and JH. According to the power source planning, the installed capacities for wind and solar power are set at 570 MW and 4497 MW, respectively. Three typical years of inflow that are wet year, normal year, and dry year are selected to test the effectiveness of the invention under different future frequency scenarios. Since MW and JH have relatively weak regulation capabilities, they operate with given monthly water levels based on historical records. The initial water levels of XW and NZD are set at 1230 m and 805 m, respectively. According to the flood and dry season variations of the river downstream, the month whose energy storage is considered as pre-flood energy storage is chosen as July. Referring to the historical water level profiles of XW and NZD, the minimum drawdown water level intervals are set as [1166 m, 1186.5 m] for XW and [765 m, 797.6 m] for NZD, respectively. The calculation results show that the minimum and maximum cascade pre-flood energy storage are 13.15 billion kWh and 20.13 billion kWh, respectively. Within the storage range, nine typical levels of pre-flood energy storage are discretized evenly with a step size of 0.88 billion kWh for risk-benefit analysis, labeled as 1 to 9. The minimum year-end energy storage requirement for the cascade hydropower system is 22.13 billion kWh. Based on relevant policies and historical operational experience, the thresholds for water spillage and power curtailment are set at 6% and 10%, respectively.

FIG. 3 illustrates relationships between pre-flood energy storage of cascade hydropower plants and probabilities of various risks. It can be observed that in wet years, there is almost no risk of insufficient year-end energy storage or power shortage during the dry period, but there are considerable risks of water spillage and wind and solar power curtailment. Under the highest pre-flood storage level, the risks of water spillage and wind and solar power curtailment reach 0.54 and 0.84, respectively. Conversely, in dry years, there are no risks of water spillage or wind and solar power curtailment. However, excessively high pre-flood storage leads to insufficient water during the dry period and significant power shortage risks, with the maximum pre-flood storage corresponding to a risk probability of 1. Additionally, if the pre-flood energy storage is too low in dry years, insufficient water storage during the flood season often results in the inability of hydropower stations to meet minimum year-end energy storage requirements. The insufficient energy storage risk probabilities corresponding to pre-flood storage levels 1, 2, and 3 are 0.306, 0.175, and 0.095, respectively. In normal years, the year-end energy storage is almost always sufficient, making the risk negligible. However, pre-flood storage levels 7, 8, and 9 bring notable dry-season power shortage risks of 0.085, 0.204, and 0.52, respectively. As pre-flood energy storage increases, flood-season water spillage increases significantly, especially beyond storage level 5. In contrast, the risk of power curtailment rises properly with increased pre-flood energy storage. The risk ranges for water spillage and power curtailment are [0.02, 0.34] and [0.04, 0.15], respectively

According to the risk relationship shown in FIG. 3, decision-makers can make choices within a certain risk tolerance. For example, assuming a tolerance level of 20%, the pre-flood energy storage in wet years should be controlled below storage level 4 to avoid excessive water spillage and power curtailment risks. In normal years, it can be moderately increased but should not exceed storage level 6 to prevent high risks of water spillage. In dry years, a balance can be struck between storage levels 2 and 5. Furthermore, the determination of pre-flood energy storage can also refer to subsequent risk loss and benefit analyses.

The distribution of risk losses and risk values (at a 95% confidence level) for risk probabilities greater than 0.05 were further statistically analyzed. From FIG. 4 and Table 1, it is evident that under the same pre-flood storage, higher inflows correspond to lower dry-season power shortage risk values but higher flood-season water spillage risk values. Moreover, greater risks generally correspond to higher risk losses, i.e., larger risk values. Taking the dry-season power shortage loss in dry years as an example, the storage level 4 corresponds to a maximum generation loss of 42.5 MW. The storage level 9 corresponds to a maximum generation loss of 423.6 MW, nearly a tenfold difference compared to that of storage level 4. However, the relationship between risk probability and risk value is not linearly proportional. For instance, in wet years, the difference in power curtailment probabilities between pre-flood storage levels 5 and 9 is 0.12 (see FIG. 3), but their risk values are nearly the same (see Table 2). This discrepancy provides decision-makers with some flexibility and further demonstrates the importance and necessity of using both risk probability and risk loss to comprehensively characterize risks. This validates the effectiveness and comprehensiveness of the risk quantification method proposed in this invention.

### Description

TABLE 1
Risk value (VaR) of water spillage

| | Pre-flood energy storage | | | | |
|---|---|---|---|---|---|
| level | 1 | 2 | 3 | 4 | 5 |
| Risk value in wet year | 59.16 | 62.47 | 62.79 | 69.71 | 73.05 |
| (100 million m³) | | | | | |
| Risk value in normal year | 9.88 | 9.75 | 9.74 | 10.71 | 11.41 |
| (100 million m³) | | | | | |

Pre-flood energy storage

| level | 6 | 7 | 8 | 9 |
|---|---|---|---|---|
| Risk value in wet year | 77.81 | 80.55 | 85.13 | 90.86 |
| (100 million m³) | | | | |
| Risk value in normal year | 13.09 | 14.13 | 15.63 | 16.94 |
| (100 million m³) | | | | |

TABLE 2
Risk value of power curtailment

| | Pre-flood energy storage | | | | |
|---|---|---|---|---|---|
| level | 1 | 2 | 3 | 4 | 5 |
| Power curtailment in wet | 59.16 | 62.47 | 62.79 | 69.71 | 73.05 |
| year (MWh) | | | | | |
| Power curtailment in normal | 9.88 | 9.75 | 9.74 | 10.71 | 11.41 |
| year (MWh) | | | | | |

Pre-flood energy storage

| level | 6 | 7 | 8 | 9 |
|---|---|---|---|---|
| Power curtailment in wet | 77.81 | 80.55 | 85.13 | 90.86 |
| year (MWh) | | | | |
| Power curtailment in normal | 13.09 | 14.13 | 15.63 | 16.94 |
| year (MWh) | | | | |

FIG. 5 shows the energy production of the system under different pre-flood energy storage levels. As pre-flood energy storage increases, water consumption during the dry season decreases, flood-season water storage reduces, and both the water head and water consumption increase. Therefore, the power generation during the dry season decreases with increasing pre-flood energy storage, while power generation during the flood season increases. The total power generation in both wet years and dry years decreases as pre-flood energy storage increases. This is because, in wet years, excessively high pre-flood energy storage leads to increased water spillage losses, reducing generation efficiency. In dry years, the lower pre-flood energy storage results in higher water consumption for power generation, thus improving generation efficiency. Benefit analysis can compensate for limitations of risk analysis alone when evaluating pre-flood energy storage. For example, as previously mentioned, the pre-flood energy storage during normal years should ideally be controlled below storage level 6. From FIG. 5, storage level 5 achieves the highest benefit with relatively low risk values (see Tables 1 and 2), indicating that using the pre-flood energy storage at level 5 is appropriate.

To further validate the invention, long-term simulations of system benefits and risks were conducted and compared with a common long-term stochastic expected scheduling model. Using benefit and risk analysis results, the pre-flood energy storage decisions are simulated. Thus, the pre-flood energy storage of the cascade hydropower system was obtained by solving the compared model. The results are summarized in Table 3.

TABLE 3
Pre-flood energy storage decision scheme

| Typical | | | |
|---|---|---|---|
| water year | Wet year | Normal year | Dry year |
| The present | Level 1 | Level 5 | Level 4 |
| invention | (13.20 | (16.64 | (15.57 |
| | billion kWh) | billion kWh) | billion kWh) |
| The | 18.21 | 19.79 | 19.83 |
| comparative | billion kWh | billion kWh | billion kWh |
| model | | | |

Based on the determined pre-flood energy storage, the long-term scheduling for both methods was simulated. A uniform drawdown rule is used during the drawdown period, while the proposed water storage rules are utilized during water storage adjustment period. Table 4 shows results of multi-year simulations. As can be shown, the pre-flood storage control from this invention outperformed the comparison method in power generation, dry-season power shortages, wind and solar power curtailment, and flood-season water spillage, despite slightly lower year-end energy storage. The average risk loss decreased by 42%. This is because the invention chooses a proper pre-flood energy storage than can effectively avoid various risks, demonstrating the method's effectiveness and practicality under typical multi-year hydrological conditions.

### DESCRIPTION

TABLE 4
Comparison of Simulation Indicators

| | | | | Flood- | Year- |
|---|---|---|---|---|---|
| | | Dry- | | season | end |
| | Energy | season | Wind and | water | Energy |
| | production | power | solar | spillage | storage |
| | (billion | shortage | curtailment | (billion | (billion |
| Method | kWh) | (MW) | (MWh) | m³) | kWh) |
| The present | 69.65 | 30 | 40203 | 30.2 | 25.5 |
| invention | | | | | |
| The | 69.07 | 230.8 | 47191 | 39.3 | 25.6 |
| comparative | | | | | |
| model | | | | | |

1. A method for risk analysis and control of pre-flood energy storage in a cascade hydro-wind-solar complementary system, comprising the following steps:
(1) constructing a dry-season drawdown optimization model based on the constraints of cascade pre-flood energy storage, monthly electricity generation control during the dry season, and conventional hydropower operation restrictions; the model is used to obtain the optimal dry-season drawdown plan; the objective function of the dry-season drawdown optimization model is as follows:
$$Max E = {\sum }_{j ∈ J} {\sum }_{n ∈ N} {\sum }_{t ∈ {T}_{1}} {P}_{j} ( \cdot {Ph}_{j , n , t} + {Pwp}_{j , t} ) Δ t \qquad ( 1 )$$
Where E is the expected generation for each scenario; J,T₁,N denote the runoff uncertainty scenarios, the number of dry-season scheduling periods and the set of hydropower stations, respectively, and j,t,n are corresponding set elements; P; is the probability of scenario j; Ph_{j,n,i} is the generation of hydropower station n of scenario j at time period t; Pwp_{j,i} is the wind and solar generation of scenario j at time period t; Δt is the duration(s) of each time period;
the pre-flood energy storage constraints and monthly electricity generation control constraints during the dry season are defined as follows:
1) cascade pre-flood energy storage constraint
$${\sum }_{n ∈ N} {E}_{n , {T}_{1}} = {E}_{tar} \qquad ( 2 )$$
$${E}_{n , {T}_{1}} = \frac{{V}_{n , {T}_{1}} + {\sum }_{nn ∈ {Ω}_{n}^{2}} {W}_{nn , {T}_{1}}}{{η}_{n}}$$
where E_{n,T}_{₁} is the pre-flood storage capacity of hydropower station n; Eₜₐᵣ is the pre-flood energy storage target; V_{n,T}_{₁} refers to the storage volume of hydropower station n at the end of time horizon;
$${\sum }_{nn ∈ {Ω}_{n}^{2}} {W}_{nn , {T}_{1}}$$
refers to the sum of storage volume for upstream stations of hydropower station n, and Ωₙ², is the set of upstream stations of hydropower station n; ηₙ is the average water consumption rate of hydropower station n;
2) monthly electricity generation control constraints during the dry season
$$\vert \frac{{\sum }_{n ∈ N} {Ph}_{j , n , t} + {Pwp}_{j , t}}{{\sum }_{t = 1}^{{T}_{1}} ( {\sum }_{n ∈ N} {Ph}_{j , n , t} + {Pwp}_{j , t} )} - {K}_{t} \vert \leq ξ ∀ j , ∀ n , t ∈ {T}_{1} \qquad ( 3 )$$
where Kₜ is the control ratio of generation production at time period t to the total during the dry season; ξ is the control error;
the Gurobi solver is used as the modeling and solution platform; Python programming, in combination with the Pyomo modeling language, is employed to linearize nonlinear constraints in the dry-season drawdown optimization model and convert the problem into a mixed-integer linear programming (MILP) formulation;
(2) operation rules for water storage are constructed, including a five-stage hedging rule and an allocation method for cascade power generation; the cascade power generation allocation is determined using the K-value discrimination method;
(2.1) develop hedging operation rules: A parametric linear optimization method is established using a Python-Pyomo modeling program to construct a five-stage hedging operation rule, which determines monthly power generations of the hydro-wind-solar complementary system; the operation principle is illustrated in FIG. 1; in the figure, OAGD represents a traditional three-stage operation rule for the hydro-wind-solar complementary system; where OA denotes the generation range below the guaranteed level; AG represents the guaranteed generation segment, and GD denotes the increased generation segment; the hedging operation rule proposed in the present invention builds upon this three-stage framework by introducing two additional points, B and C, between the AG and GD segments; this forms a five-stage hedging rule, OABCD, which includes a hedging segment BC; in this rule, the horizontal coordinates of the intersection points between segment BC and segments AG and GD are defined as parameters a and b, respectively; these parameters are determined through optimization based on historical power generation records from hydropower, wind, and solar power sources; the specific expressions for calculating a and b are as follows:
$$Min D = {\sum }_{t}^{{T}_{2}} \vert {kE}_{t} + d - {P}_{t} \vert \qquad ( 4 )$$
where k and d are the slope and intercept of the curve BC; E₁ is the historical average available energy of the complementary system at time period t; T₂ is the number of periods during the storage adjustment period; Pₜ is the historical average generation at time period t; As BC intersects with sections AB and GD, a and b are calculated with the consideration of expressions for sections AB and GD, shown in the following equation:
$$a = \frac{{P}_{f} - d}{k} \qquad ( 5 )$$
$$b = \frac{[ ( d - 1 ) {P}_{f} Δ m + {dE}_{m}^{s} ] Δ m}{1 - k Δ m} \qquad ( 6 )$$
where P_{M} is the maximum generation of the hydro-wind-solar complementary system; P_{f} is the guaranteed generation of the complementary system; Eₘ^{s} is the available energy storage of the full storage of cascade hydropower stations; Δm is the number of hours in a month;
(2.2) cascade generation allocation: After obtaining monthly total generation of the hydro-wind-solar complementary system in step (2.1), the residual generation after deducting the wind and solar generations is allocated among cascade hydropower stations; the K-value discrimination method is applied to determine the sequence of water storage and release for the cascade system; specifically, during the storage phase, stations with higher K-values are prioritized for water storage; during the supply phase, stations with lower K-values are prioritized for power generation; the discriminant value K for hydropower station n is calculated as follows:
$$Δ {E}_{x} = {W}_{n} / {φ}_{n}^{{V}_{n}} ( Δ {V}_{n} ) + {\sum }_{k ∈ {Ω}_{n}^{3}} Δ {V}_{n} / {η}_{k} \qquad ( 7 )$$
$$Δ {E}_{𝓏} = {\sum }_{k ∈ {Ω}_{n}^{2}} ( {V}_{k} + {W}_{k} ) / {φ}_{n}^{{V}_{n}} ( Δ {V}_{n} ) \qquad ( 8 )$$
$${K}_{n} = \frac{Δ {E}_{𝓏}}{Δ {E}_{x}} = \frac{{\sum }_{k ∈ {Ω}_{n}^{2}} ( {V}_{k} + {W}_{k} )}{{W}_{n} + {φ}_{n}^{{V}_{n}} ( Δ {V}_{n} ) \times {\sum }_{k ∈ {Ω}_{n}^{3}} Δ {V}_{n} / {η}_{k}} \qquad ( 9 )$$
where ΔEₓ denotes the energy added to hydropower station n and downstream stations due to the storage of water ΔVₙ in station n; Wₙ/φₙ^{V}^{ₙ} (ΔVₙ) is the incremental energy in the hydropower station n due to the increase in water head, Wₙ is the current storage volume of hydropower station n;
$${\sum }_{k ∈ {Ω}_{n}^{3}} Δ {V}_{n} / {η}_{k}$$
is the energy added to downstream hydropower stations due to the storage of water ΔVₙ in hydropower station n, and Ωₙ² denotes the set of downstream hydropower stations of power station n; ΔVₙ is the unit storage volume in hydropower station n; ηₖ is the average water consumption rate in hydropower station n from the initial water level to the stored water level; ΔE_{z} denotes the energy added to the upstream hydropower plant due to water storage ΔVₙ at hydropower station n; Ωₙ², denotes the set of upstream stations of hydropower station n; Vₖ denotes the amount of water stored above the dead storage volume of upstream hydropower station n, and Wₖ is the amount of interval inflow of hydropower station k; φₙ^{V}^{ₙ} (⋅) is a relationship function between changes in the unit storage volume and changes in the water consumption rate when the storage volume of hydropower station n is Vₙ;
(3) using fuzzy theory to characterize high-dimensional, multiple uncertainty probabilities of runoff, wind power and solar power;
(3.1) assuming that the forecast errors of runoff and wind/solar power generation are fuzzy variables, and that the distribution of these forecast errors follows a Cauchy distribution, the membership function representing the prediction error ε of runoff or wind and solar power generation is expressed as follows:
$$μ ( ε ) = \{ \begin{matrix}\frac{1}{1 + {σ ( ε / EP )}^{2}} & ε > 0 \\ \frac{1}{1 + {σ ( ε / EP )}^{2}} & ε \leq 0\end{matrix} \qquad ( 10 )$$
where EP and EN are statistical means of the positive and negative errors in the uncertainty sets for runoff or wind and solar power generation, and σ is a weight;
(3.2) the Python programming language is used to import long-sequence predicted and historical records of runoff and wind/solar power generation data from Excel files; the cauchy.fit function included in the SciPy library is then employed to fit the Cauchy distribution parameters to the calculated prediction error data;
(3.3) to represent the comprehensive membership degree between runoff and wind/solar power generation at each power station within the same time period, as well as across different time periods, the following two types of fuzzy relationships are defined:
the fuzzy relationship between the runoff and wind/solar power generation during the same time period is defined as follows:
$${h}_{1} ( Q {1}_{t} , Q {2}_{t} , … , Q {n}_{t} , {Pwp}_{t} ) = min \{ f ( Q {1}_{t} ) , f ( Q {2}_{t} ) , … , f ( Q {n}_{t} ) , f ( {Pwp}_{t} ) \} \qquad ( 11 )$$
where Q1ₜ, Q2ₜ, . . . , Qnₜ are the inflow or interval flow of hydropower stations 1, 2, . . . , n at time period t, respectively; Pwpₜ is the wind and solar power generation at time period; f(⋅) is the corresponding membership degree function;
the fuzzy relationship between the runoff and wind/solar power generation at different time periods is expressed as follows:
$${h}_{2} ( {Q}_{1}^{n} , {Q}_{2}^{n} , … , {Q}_{T}^{n} ) = min \{ f ( {Q}_{1}^{n} ) , f ( {Q}_{2}^{n} ) , … , f ( {Q}_{T}^{n} ) \} \qquad ( 12 )$$
$${h}_{3} ( {Pwp}_{1} , {Pwp}_{2} , … , {Pwp}_{T} ) = min \{ f ( {Pwp}_{1} ) , f ( {Pwp}_{2} ) , … , f ( {Pwp}_{T} ) \} \qquad ( 13 )$$
Where h₂(⋅) and h₃(⋅) are the fuzzy relationship between the runoff at different time periods and between the wind and solar power generation at different time periods, denoting the comprehensive membership degree; Q₁ⁿ, Q₂ⁿ, . . . , Q_{T}ⁿ are the runoff of the power station n at time periods 1, 2, . . . , T; Pwp₁, Pwp₂, . . . , Pwp_{T} are the wind and solar power generations at time periods 1, 2, . . . , T;
(4) key risk indicators for both flood and dry season are selected to establish a comprehensive set of critical risk indexes for the hydro-wind-solar complementary system, shown as follows:
(4.1) the risk of power shortage in the dry season, denoted as Rₛ, is defined as follows:
$${R}_{s} = \frac{sum \{ {P}_{i}^{shortage} \}}{I} i ∈ I \qquad ( 14 )$$
$${P}_{i}^{shortage} = \{ \begin{matrix}1 ∃ {P}_{i , t} < {P}_{f} & t ∈ {T}_{1} \\ 0 ∀ {P}_{i , t} \geq {P}_{f} & t ∈ {T}_{1}\end{matrix} \qquad ( 15 )$$
where Pᵢ^{shortage} is the risk value of generation deficit under scenario i, Pᵢ^{shortage} is set to 1 if risk exists otherwise 0; P_{i,t} is the system generation value at time period t of scenario i; I is the total number of simulated scenarios; T₁ is the total number of time periods during the dry season; P_{f} is the guaranteed generation for the hydro-wind-solar complementary system;
(4.2) the water spillage risk in the flood season, denoted as R_{w}, is defined as follows:
$${R}_{w} = \frac{num \{ {S}_{i} > Sd \}}{I} i ∈ I \qquad ( 16 )$$
$${S}_{i} = {\sum }_{t = 1}^{{T}_{2}} {spill}_{i , t} t ∈ {T}_{2} \qquad ( 17 )$$
where Sᵢ represents the spilled water in scenario i; Sd is the spillage control threshold; spill_{i,j} represents the spilled water in scenario i at time period t.
(4.3) the risk of insufficient year-end energy storage, denoted as Rₑ, is defined as follows:
$${R}_{e} = \frac{n u m \{ {Eend}_{i} < {E}_{min} \}}{I} i ∈ I \qquad ( 18 )$$
where Eendᵢ is the energy storage at the end of a year in scenario i; Eₘᵢₙ is the minimum requirement for energy storage of the system at the end of a year, below which the energy storage is deemed inadequate;
(4.4) the risk of wind and solar power curtailment, denoted as R_{c}, is defined as follows:
$${R}_{c} = \frac{n u m \{ {C}_{t} > Cd \}}{I} i ∈ I \qquad ( 19 )$$
$${C}_{i} = {\sum }_{t 1}^{T} {curtail}_{i , t} t ∈ T \qquad ( 20 )$$
$${curtail}_{i , t} = f ( {Ph}_{i , t} ) t ∈ T \qquad ( 21 )$$
Where Cᵢ is the wind and solar power curtailment of scenario i; Cd is the threshold of wind and solar power curtailment; curtail_{i,t} is the wind and solar power curtailment of scenario i at time period t; f(⋅) is the power curtailment function of the hydro-wind-solar complementary system; Ph_{i,t} is the hydropower generation of scenario i at time period t; T is the number of time periods in a year;
the risks of power shortage during the dry season, water spillage during the flood season, insufficient energy storage at the end of a year, and wind and solar power curtailment for each scenario are respectively calculated as follows:
$${L}_{i}^{s} = {\sum }_{t = 1}^{{T}_{1}} {μ}_{i , t} \times max \{ {P}_{f} - {P}_{i , t} , 0 \} \qquad ( 22 )$$
$${L}_{i}^{w} = {μ}_{i} \times {S}_{i} \qquad ( 23 )$$
$${L}_{i}^{e} = {μ}_{i} \times max \{ {E}_{min} - {Eend}_{i} , 0 \} \qquad ( 24 )$$
$${L}_{i}^{c} = {μ}_{i} \times {C}_{i} \qquad ( 25 )$$
where Lᵢ^{s}, Lᵢ^{w}, Lᵢ^{e}, Lᵢ^{c} are index loss values of Rₛ, R_{w}, Rₑ and R_{c}, respectively; μ_{i,t} is the fuzzy membership degree of scenario i at time period t; μᵢ is the comprehensive fuzzy membership degree of scenario I;
(5) quantification of risks for dry-season power shortages, flood-season water spillage, wind and solar power curtailment, and insufficient energy storage at the end of a year;
the prediction errors of runoff, wind, and solar power generation are represented as fuzzy variables; wind and solar power generation are collectively referred to as new energy sources, without the consideration of their differences; the steps for quantifying risks are as follows:
(5.1) based on historical records of the runoff and prediction and historical data of wind/solar power generation, the cauchy.fit function from the Python-Scipy library is utilized to calculate the parameters of membership functions of runoff and wind/solar power generation; thus, the fuzzy membership degree functions f^{z}(ξₘ³) of the runoff prediction error and new energy generation prediction error can be determined, respectively, (1≤m≤12, 1≤z≤Z); here, z denotes the uncertainty variable of the runoff or wind/solar power generation; m denotes the month index;
(5.2) based on the error membership degree functions of the runoff and the wind/solar power generation, a series of real numbers ε_{m,k}^{z} and the corresponding membership degree μ(ε_{m,k}^{z}) (k=1, 2, . . . , N) are randomly generated using the Monte Carlo simulation method in the Python-random program package; N is the number of random numbers;
(5.3) simulation operations are performed; during the dry season, monthly simulations are conducted from starting from the beginning of a year, using a fixed water level calculation based on the dry-season drawdown plan; for any a month, a series of ε_{m,k}^{z} based on the initial and ending water levels in the plan are generated; thus, a series of total generation of the complementary system Ps_{m,k} and dry-season wind and solar power curtailment Cₖ¹ are obtained, and the membership degree h({ε_{m,k}^{z}}) can be determined; when the ending water level in the plan is infeasible, the simulated value replaces it in further calculations; during the flood season, the five stage operation rule is used for monthly simulations; Starting from the beginning of the flood season, a series of εₖ^{z} are generated; here is εₖ^{z}={ε_{ml,k}^{z}, ε_{ml+1,k}^{z}, ε_{ml+2,k}^{z}, . . . , ε_{12,k}^{z}} for any scenario εₖ^{z}; thus, the year-end energy storage Eendₖ, flood-season wind and solar power curtailment Cₖ², flood-season water spillage Sₖ, and their corresponding membership degrees h({εₖ^{z}}) are obtained, respectively, f(εₖ^{z})=h(ε_{ml,k}^{z}, ε_{ml+1,k}^{z}, . . . , ε_{12,k}^{z}); ml represents the starting month of the flood season; the sum of Cₖ¹ and Cₖ² is the annual wind and solar power curtailment in the scenario k;
(5.4) the indicators Rₛ, R_{w}, Rₑ, R_{c} and Lᵢ^{s}, Lᵢ^{w}, Lᵢ^{e}, Lᵢ^{c} for dry-season power shortages, flood-season water spillage, inadequate year-end energy storage, and wind and solar power curtailment are calculated according to step (3);
(5.5) for other hydropower plants in the cascade, the steps (5.2) to (5.6) are repeated to pre-calculate flood energy storage values; finally, detailed relationships between cascade energy storage and dry-season power shortage, flood-season water spillage, inadequate year-end energy storage, and wind and solar power curtailment are obtained.
